(19) United States
(12) Patent Application Publication
(10) Pub. No.: US 2008/0225779 A1
(43) Pub. Date: Sep. 18, 2008

(54) LOCATION-BASED NETWORKING SYSTEM AND METHOD

(76) Inventors: Paul Bragiel, San Francisco, CA (US); Sam Stauffer, San Francisco, CA (US); Antonios Proios, Palo Alto, CA (US); Wendell Davis, New York, NY (US); Wojtek Podgorski, Wroclaw (PL)

Correspondence Address: PERKINS COIE LLP, P.O. BOX 1208, SEATTLE, WA, 98111-1208, US

(21) Appl. No.: 11/868,955

(22) Filed: Oct. 8, 2007

Related U.S. Application Data
(60) Provisional application No. 60/850,710, filed on Oct. 9, 2006.

(51) Int. Cl. H04Q 7/00

(52) U.S. Cl. 370/328

(57) ABSTRACT

A technique for creating a network model involves receiving location data associated with objects and using the location data to improve the size and/or accuracy of the network model. A technique for creating geo-tagged content involves providing a probable location associated with a client and geo-tagging content at that location.

### CROSS-REFERENCE TO RELATED APPLICATIONS

This application claims priority to U.S. Provisional Application 60/810,710, entitled LOCATION-BASED NETWORKING SYSTEM AND METHOD, filed Oct. 9, 2006, which is hereby incorporated by reference in its entirety.

### BACKGROUND

Portable computers are often operated without a coupling that forms a physical connection between the computer and the location in which it is used. While GPS and other positioning technologies exist, most portable devices do not make use of the positioning technologies. Positioning technologies may be too large to fit inside all devices, or it may be too expensive. There is a limit to what hardware would be desirable in a given device.

Even devices that use the positioning technologies do not tie their positioning to the physical location in any meaningful sense. For example, a GPS device may inform a user that the user is located at a given latitude and longitude, but not tie that knowledge to any other applications without the user actually entering the data. On the other hand, some devices make use of positioning (for example, some high-end cameras allow a user to take a picture that is position-stamped). Such devices are typically hard-coded to make use of position data in a particular manner.

These and other issues are addressed, resolved, and/or ameliorated using techniques described herein.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for creating a network model involves receiving location data associated with objects and using the location data to improve the size and/or accuracy of the network model. A system according to the technique may include an interface for receiving first location data associated with a first object and second location data associated with a second object, a database that includes locations, a location calculation module, and an organic growth module. In operation, a processor may, for example, execute the location calculation module to determine the distance or relative location with respect to the first object and the second object. One example of determining the distance or relative location with respect to the first object and the second object may include predicting a first location associated with the first object by comparing the first location data to locations in the database; predicting a second location associated with the second object by comparing the second location data to locations in the database; comparing the first location and the second location. Alternatively or in addition, the processor may, for example, execute the organic growth module to add new locations to the database when the first location data or the second location data identify the new locations.

Another example of a system according to the technique may include a wireless network database, a scouting module, and a headquarters module. The wireless network database may include, for example, information about a physical network, wherein the information facilitates creation of a known network model associated with the physical network. The scouting module may be, for example, for identifying network-related data in the physical network. The headquarters module may be, for example, for improving accuracy and/or expanse of the known network model using network-related data received from the scouting module.

A technique for creating geo-tagged content involves providing a probable location associated with a client and geo-tagging content at that location. A method according to the technique may include, for example, providing a probable location associated with a client; receiving content from the client; associating the probable location of the client with the content received from the client; storing the content in association with the probable location of the client.

These and other advantages of the present invention will become apparent to those skilled in the art upon a reading of the following descriptions and a study of the several figures of the drawings.

### BRIEF DESCRIPTION OF THE DRAWINGS

Embodiments of the present invention are illustrated in the figures. However, the embodiments and figures are illustrative rather than limiting; they provide examples of the invention.

FIG. 1 depicts an example of a system that includes a wireless access area and a location platform.

FIG. 2 depicts a flowchart of an example of a method for determining location using a network topology.

FIG. 3 depicts a computer system for use in the system of FIG. 1.

FIG. 4 depicts an example of an organic wireless client location detection system 400.

FIGS. 5A and 5B depict an example of a known wireless network that grows organically over time.

FIG. 6 depicts an example of a system for tying data to a location.

FIG. 7 depicts a flowchart of an example of a method for writing virtual graffiti.

FIG. 8 depicts a flowchart of an example of a method for reading virtual graffiti.

FIGS. 9A and 9B depict an example of a system for geo-matching objects.

The foregoing examples of the related art and limitations related therewith are intended to be illustrative and not exclusive. Other limitations of the related art will become apparent to those of skill in the art upon a reading of the specification and a study of the drawings.

### DETAILED DESCRIPTION

In the following description, for the purposes of explanation, numerous specific details are set forth in order to provide a thorough understanding of the present invention. It will be apparent, however, to one skilled in the art that the present invention may be practiced without one or more of these specific details or in combination with other components or process steps. In other instances, well-known structures and devices are shown in block diagram form in order to avoid unnecessarily obscuring the present invention.

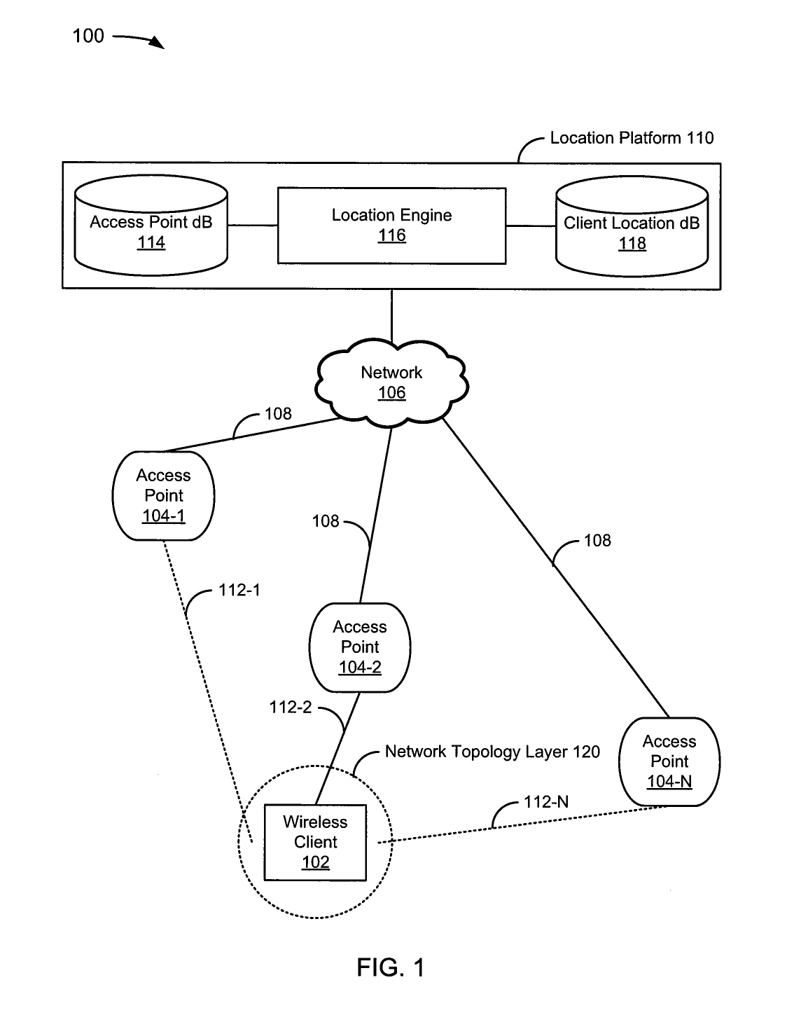

Learn network topology around you. An example of how this can be accomplished in a wireless environment is illustrated in FIG. 1. FIG. 1 depicts an example of a system 100 that includes a wireless access area and a location platform. In the example of FIG. 1, the system 100 includes a wireless client 102, a plurality of access points 104-1 to 104-N (referred to collectively as access points 104), a network 106, and a location platform 110.

The wireless client 102 may include any known or convenient wireless device that can communicate with an information network. The access points 104 may be referred to as access points, and typically include a radio transceiver for communicating with a wireless device. The network 106 may include any known or convenient network environment, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). The physical connections of the Internet and the protocols and communication procedures of the Internet are well known to those of skill in the relevant art. The access points 104 are coupled to the network 106. The coupling 108 typically includes a switch (not shown) or some other exchange device, though the specific implementation may be anything known or convenient. The location platform 110 may include any known or convenient computer and, in an embodiment, includes a server.

In the example of FIG. 1, the location platform 110 includes an access point database 114, a location engine 116, and a client location database 118. The access point database 114 includes data associated with all of the access points 104. (Note: It is assumed that all of the access points 104 are known in the access point database 114, but if one or more were not, they could be added or ignored as appropriate.) The location engine 116 may include a known or convenient processor and memory. Programs or procedures associated with the location engine 116 may be loaded into memory from storage in a manner that is known in the relevant arts. The client location database 118 includes the current location of the wireless client 102, if available, and other wireless clients (not shown), if available.

Typically, a user of the wireless client 102 is not always actively using the wireless client 102, even when the wireless client is on. For example, the wireless client 102 may include a cell phone. The wireless client 102 might be thought of as “offline” when the cell phone is on, but not being used. However, modem cell phones typically have incoming and outgoing data even when they are not actively used. This data can be used to locate the wireless client 102, often with as much accuracy as when the wireless client 102 is being actively used. Therefore, for the purposes of this application, a client is considered offline with respect to a network if the client is not detectable on the network. This may happen, for example, if the client is not logged onto the service associated with the location platform 110 or logs off of the service.

The location of the wireless client 102 may not be available when, for example, the wireless client 102 goes offline. In this case, there may be a number of options, including assuming the wireless client 102 is at the last detected location, assuming the wireless client 102 is at a location identified in a client-related profile, or by using a location sent explicitly from the wireless client 102 before going offline. If a user receives a location-filtered email, and the location is guessed wrong, the location-filtered email may be filtered improperly, or may be sent to the wireless client 102 when it comes back online, even though it should have been filtered. Since the client is offline, the predicted location may be substantially different than the actual location, which can result in errors with respect to location-based emails and alerts. Therefore, it may be desirable to queue location-based messages until such time as the wireless client 102 comes online again, and a more accurate prediction of location can be made. In some cases, coming online may be treated as moving near a location, such that alerts triggered by entering a location are only triggered when the client comes online within the location. In another embodiment, an offline wireless client 102 is treated as having no location. Location-related filters for email and other mechanisms that are described later could be queued for when a location is identified for the wireless client 102 again, at which point location-based filters could be applied.

In operation, the wireless client 102 negotiates with the access points 104. Typically the wireless client 102 chooses the access point that is approximately closest to the wireless client 102 (e.g., the access point with the highest RSSI). A user of the wireless client 102 may also have the ability to choose between some or all of the access points 104. Eventually, the wireless client 102 settles on one of the access points 104. The wireless client may even completely ignore access points that are only intermittently detectable or that have insufficient strengths.

In the example of FIG. 1, it is assumed that the wireless client 102 associates with the access point 104-2 (as illustrated by the solid line 112), but is not associated with the other access points (as illustrated by the dashed lines 112). However, a network topology layer 120 captures all of the data associated with access points 104. The data collected at the network topology layer 120 can be provided to the location platform 110. For example, the client 102 could send RSSI's for each of the access points 104 to the location platform 110.

In operation, the location engine 116 may compare the data with data in the access point database 114 to determine approximate location of the wireless client 102 using, by way of example but not limitation, triangulation techniques. In some cases, the angular direction of the signal to or from an access point can even be detected, giving better than usual probability of determining an accurate location for the wireless client 102. The current location of the wireless client 102 is stored in the client location database 118, and updated if, for example, the client location changes, a better approximation of location becomes available, or for some other reason.

In some cases, for various reasons, the location engine 116 might be unable to identify the location of the wireless client 102. In such cases, if the system 100 (or the user) become aware that a predicted location is not the right location, a user may be able to enter the actual geo-location of the wireless client 102. The system 100 can then use the entered location in lieu of the predicted location. In other cases, the location engine 116 can predict a location of the wireless client 102, but it is a relative location, and the location cannot be associated with a particular geographic location with any specificity. For example, the client 102 could associate with an access point 104-2, but that access point might not be initially known, though it can be added to the database. If another wireless client (not shown) associates with the access point 104-2, however, then the system 100 may be able to figure out that the wireless clients are near one another, even though the exact location of the access point 104-2 is unknown.

The system 100 may actually be able to correct itself once the actual location is entered. For example, if the wireless client 102 roams from a first access point to a second access point, the system 100 may be able to use the entered location and a location associated with the second access point to determine the current geo-location of the wireless client 102.

In operation, the location platform 110 can learn the network topology surrounding the wireless client 102. For example, the network topology layer 120 may collect data that seems to include one or more access points that are not in the access point database 114. The location engine 116 can enter the new data into the access point database 114 to improve location detection for other wireless clients (not shown) in the system 100 near one or more of the access points 104.

The location platform 110 can receive access point data from other sources as well, such as entering access point locations directly, downloading published access point locations, or guessing where a signal is coming from (e.g., if a signal is received from approximately location X, and location X corresponds to a coffee shop on a local map, location X can be estimated to be in the coffee shop). Access point data may or may not include address information, but this could be added if the access point data includes, for example, GPS coordinates. Presumably, the location platform 110 could learn new access point locations or unlearn unused locations, or locations that the system guessed wrong about (e.g., location X could be next to the coffee shop, rather than in it.) Any known or convenient mechanism for entering new topology information is possible.

Additional data can be associated with each record in the access point database 114. For example, users of wireless clients could indicate where they are explicitly, or some wireless clients could use GPS to pinpoint their locations. As other examples, the host of an access point (e.g., a coffee shop) could indicate the location of the access point, or the location engine 114 could overlay local maps on top of data collected at the network topology layer 120 to guess locations of access points. Since GPS-to-address mappings may be inaccurate, it may be desirable to develop a table that includes mappings of GPS coordinates to addresses. Such tables may not be available publicly, but might be maintained internally at a corporation with multiple outlets in various locations. Also, users may be willing to provide an address for a GPS coordinate that is stored in the access point database 114. The location platform 110 could even explicitly ask the user to enter the address associated with a particular hot spot and “win a prize” for participating in improving the network.

The network topology layer 120 may include, by way of example but not limitation, a low level network module that communicates with system drivers to capture data (the low level network module can query which access points are seen, which router is seen, etc.) and a higher level network protocol that can send the data back to the location platform 110. In a sense, the higher level network protocol can tell the location platform 110, “I've seen these things.” The location platform 110 can then figure out where the wireless client 102 is based upon what the wireless client 102 has “seen.”

The low level network module may be implemented as a technology agnostic “physical location API.” Examples of data that may be useful to capture include IP data, Wi-Fi data, gateway data, router data, geo-tag data, cell tower data, blue tooth data, and Wi-Max data. Since the physical location API is technology agnostic, this is by no means an exhaustive list, since other protocols may exist now or in the future and other technology-specific capabilities may be implemented.

In a distributed environment, the location platform 110 may be implemented in a distributed fashion on multiple clients. However, for illustrative purposes, it is assumed that the system 100 includes a server-client implementation. This implementation has several advantages such as, for instance, each wireless client can serve as a scout that reports topology data back to headquarters (the location platform), and the location platform can crunch the numbers, which frees up the wireless client from such tasks.

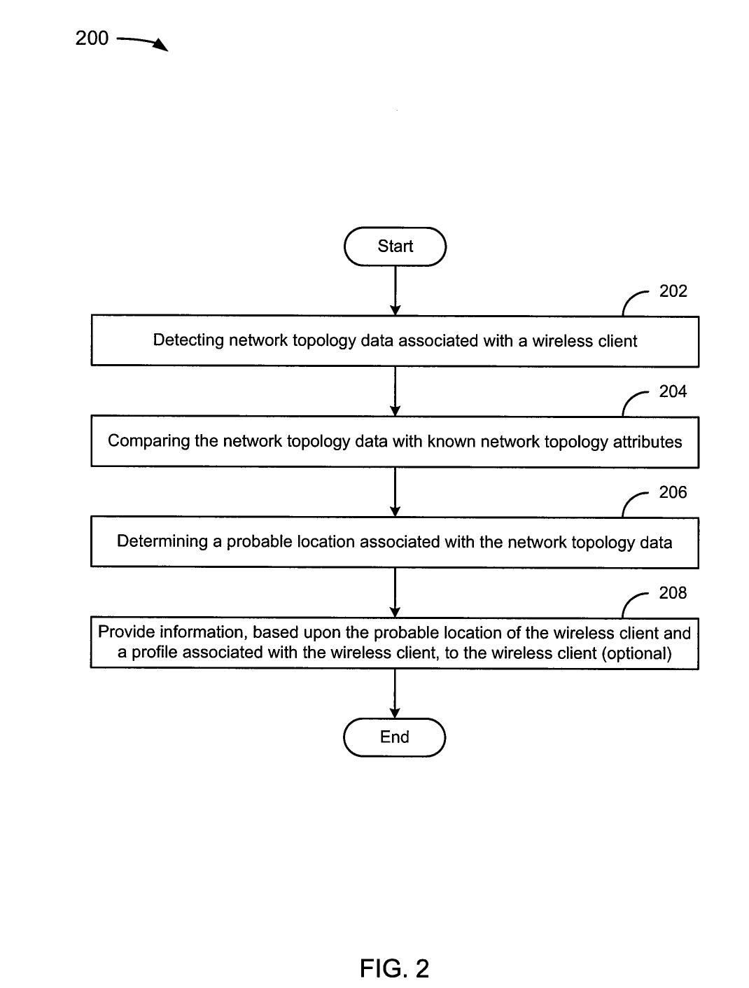

FIG. 2 depicts a flowchart 200 of an example of a method for determining location using a network topology. FIG. 2 is intended to illustrate a general method for implementing location detection in a wireless environment. While FIG. 1 illustrated the use of RSSI in triangulating a possible location of a wireless client, FIG. 2 illustrates that any applicable data can be used, including by way of example but not limitation, RSSI, router-related data, inherent properties of Wi-Fi (e.g., Wi-Fi doesn't travel very far, so detection of Wi-Fi signals typically means a client is within 100 meters or so). The data could also be related to frequency or standards, such as 802.11a, 802.11b, 802.11g, and other known or convenient standards, whether 802-compatible or not.

In the example of FIG. 2, the flowchart 200 starts at module 202 with detecting network topology data associated with a wireless client. The detection may be accomplished at a wireless client using, for example, a network topology layer that collects data associated with nearby (i.e., detectable) access points.

In the example of FIG. 2, the flowchart 200 continues to module 204 with comparing the network topology data with known network topology attributes. The known network topology attributes may be stored in a database. A location engine may compare the network topology data with the attributes by, for example, using locations associated with access points to triangulate the location of a wireless client that receives, for example, RSSIs from the access points.

In the example of FIG. 2, the flowchart 200 continues to module 206 with determining a probable location of a client associated with the network topology data. The accuracy of location detection will vary depending upon the data collected. However, some applications do not need exceptionally accurate location detection. For example, if a wireless client can be located within 300 feet (which can be accomplished in some cases using RSSI alone), that may be useful in certain social networking contexts.

In the example of FIG. 2, the flowchart 200 continues to optional module 208 with providing information, based upon the probable location of the wireless client and a profile associated with the wireless client, to the wireless client. This module is optional because it is not necessary to provide any information to a client (e.g., the client could provide data to improve the capabilities of a server to determine the probably location of other clients). Moreover, a wireless client may or may not have a profile associated with it. However, a profile can be of particular value when attempting to give the user of the wireless client useful information. For example, if the user of the wireless client indicates he likes coffee, the information provided to the wireless client could include the location of a nearby coffee shop.

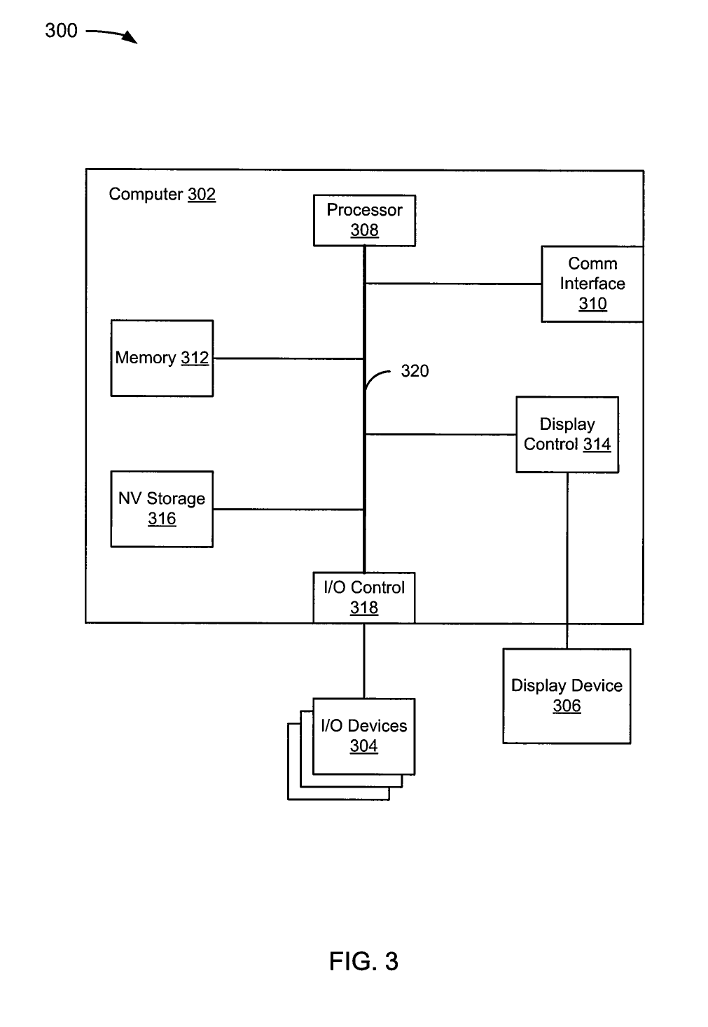

FIG. 3 depicts a computer system 300 for use in the system 100 (FIG. 1). The computer system 300 may be a conventional computer system that can be used as a client computer system, such as a wireless client or a workstation, or a server computer system. The computer system 300 includes a computer 302, I/O devices 304, and a display device 306. The computer 302 includes a processor 308, a communications interface 310, memory 312, display controller 314, non-volatile storage 316, and I/O controller 318. The computer 302 may be coupled to or include the I/O devices 304 and display device 306.

The computer 302 interfaces to external systems through the communications interface 310, which may include a modem or network interface. It will be appreciated that the communications interface 310 can be considered to be part of the computer system 300 or a part of the computer 302. The communications interface 310 can be an analog modem, ISDN modem, cable modem, token ring interface, satellite transmission interface (e.g. “direct PC”), or other interfaces for coupling a computer system to other computer systems.

The processor 308 may be, for example, a conventional microprocessor such as an Intel Pentium microprocessor or Power PC microprocessor or a microcontroller. The memory 312 is coupled to the processor 308 by a bus 320. The memory 312 can be Flash Memory or Dynamic Random Access Memory (DRAM) and can also include Static RAM (SRAM). The bus 320 couples the processor 308 to the memory 312, also to the non-volatile storage 316, to the display controller 314, and to the I/O controller 318.

The I/O devices 304 can include a keyboard, disk drives, printers, a scanner, and other input and output devices, including a mouse or other pointing device. The display controller 314 may control in the conventional manner a display on the display device 306, which can be, for example, a cathode ray tube (CRT) or liquid crystal display (LCD). The display controller 314 and the I/O controller 318 can be implemented with conventional well known technology.

The non-volatile storage 316 is often a magnetic hard disk, an optical disk, or another form of storage for large amounts of data. Some of this data is often written, by a direct memory access process, into memory 312 during execution of software in the computer 302. One of skill in the art will immediately recognize that the terms “machine-readable medium” or “computer-readable medium” includes any type of storage device that is accessible by the processor 308 and also encompasses a carrier wave that encodes a data signal.

The computer system 300 is one example of many possible computer systems which have different architectures. For example, personal computers based on an Intel microprocessor often have multiple buses, one of which can be an I/O bus for the peripherals and one that directly connects the processor 308 and the memory 312 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 312 for execution by the processor 308. A Web TV system or mobile phone, which is known in the art, is also considered to be a computer system, but it may lack some of the features shown in FIG. 3, such as certain input or output devices. A typical computer system will usually include at least a processor, memory, and a bus coupling the memory to the processor.

In addition, the computer system 300 is controlled by operating system software which includes a file management system, such as a disk operating system, which is part of the operating system software. One example of operating system software with its associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile storage 316 and causes the processor 308 to execute the various acts required by the operating system to input and output data and to store data in memory, including storing files on the non-volatile storage 316.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The descriptions of operations described herein may relate to apparatus for performing the operations. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, techniques are not described herein with reference to any particular programming language, and various embodiments may thus be implemented using a variety of programming languages.

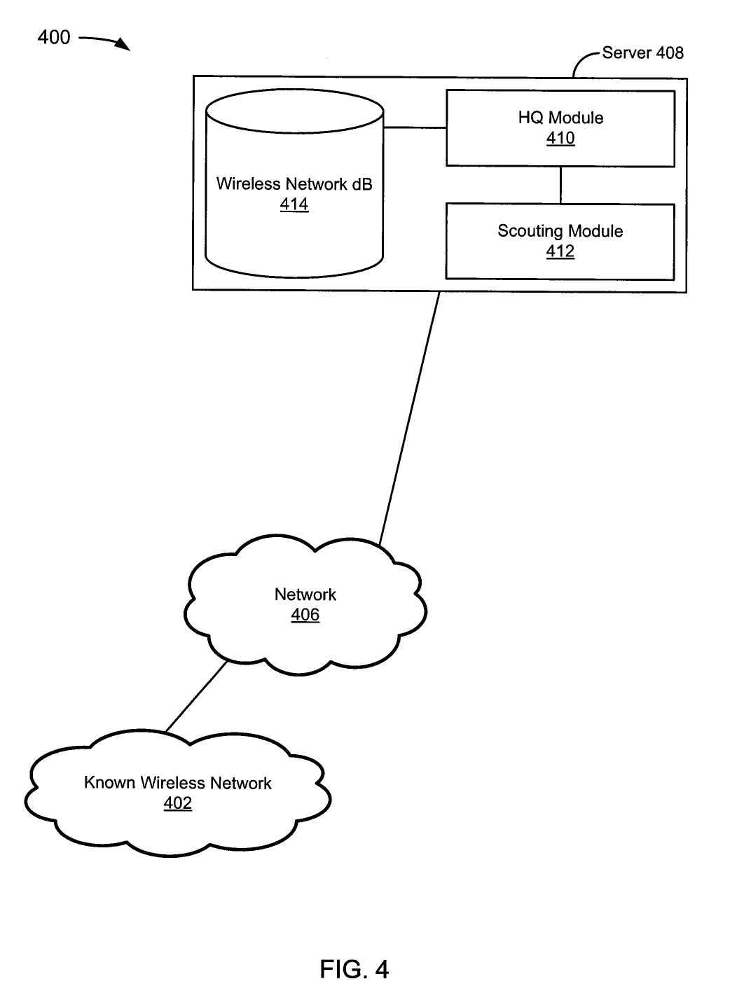

FIG. 4 depicts an example of an organic wireless client location detection system 400. The system 400 is organic because it can grow as it learns new information from wireless clients. The system 400 includes a known wireless network 402, a network 406, and a server 408. In the example of FIG. 4, the server 410 includes a headquarters (HQ) module 410, a scouting module 412, and a wireless network database 414. The scouting module 412 looks for, by way of example but not limitation, WiFi hot spots, gateways, internal networks, and other network-related data, in the known network 402 and reports the data back to the HQ module 410. When new network information is found, the HQ module 410 can update the network database 414 with the new data, thereby expanding the size or improving the model of the known network 402. The known network 402 can be self-sustaining and self-repairing over time as data is provided, causing the known network 402 to organically grow (or shrink) over time.

In an embodiment, the scouting module 412 is in the low level network and looks for not only hot spots, but also data related to communication links, such as by way of example but not limitation, an Ethernet card. The scouting module 412 may collect from a user an IP address, a MAC address, router information, external IP address-related data, or other known or convenient data that can be used to locate the user and report the data to the HQ module 410 for analysis. In general, the scouting module 412 simply attempts to collect as much data as is known to exist with respect to the clients and their communication-related data. If advances in the state-of-the-art result in additional parameters, the scouting module 412 may be configured to collect the additional parameters. The combination of the IP address, MAC address, router information, External IP, and/or other known or convenient parameters can serve as a fingerprint for a wireless client. By comparing the fingerprint to the known wireless network data in the network database 414, the HQ module 412 can identify a probable location at which a user is operating.

It may be noted that certain techniques may make location detection more difficult, such as VLAN tunneling. However, the system 400 can give priority to router information to make up for some of these difficulties. In a system that does not require pinpoint accuracy of location, such as in a social networking environment, the router data, or equivalent data can be useful in determining location to within hundreds of feet.

It may be noted that certain known techniques allow for extremely local location detection. For example, if two users are logged into the same Wi-Fi hot spot, the users could be identified as local with respect to one another. Or, two users could share names (e.g., SSN), they could be identified as local with respect to one another. Or, two routers could be given the same name, which would imply they are in the same (local) area. Moreover, the extremely local location detection techniques typically do not know where they are. Rather, they simply know that two users are predicted to be relatively close to one another, without any knowledge of geo-location. Moreover, the extremely local location detection techniques typically, by themselves, do not scale. Advantageously, the techniques described herein—with respect to, for example, the scouting module 412 to gather data for the HQ module 410 and the location platform 110 (FIG. 1)—could make use of known extremely local location detection techniques in addition to scalable location detection techniques.

In an embodiment, the HQ module 410 can use data collected with respect to one user to provide data to another user. For example, a first user may have designated a second user as a “buddy” who should be informed when the first user is within 600 feet. Many other implementations are possible using the techniques described herein, some of which are described later.

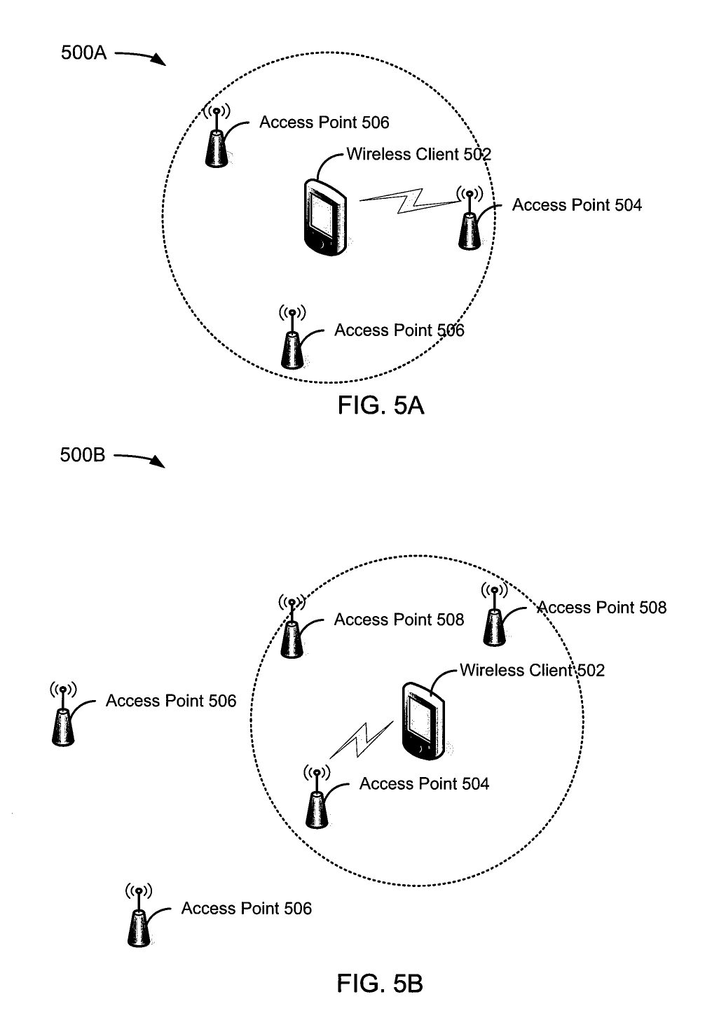

FIGS. 5A and 5B depict an example of a known wireless network that grows organically over time. In the example of FIG. 5A, a wireless client 502 is in the wireless network 500A, which includes an access point 504 and access points 506. For illustrative purposes, only, the wireless client 502 is associated with the access point 504, but can see the access points 506. What the wireless client 502 can see is represented as a dashed circle around the wireless client 502. The known wireless network 500A may include a database with data associated with the access points 504, 506, or the database may be updated based upon what the wireless client 502 sees.

In the example of FIG. 5B, in the known wireless network 500B, the wireless client 502 has, for illustrative purposes only, moved away from the access points 506 toward access points 508. Thus, the known wireless network 500B, which still includes the access points 506, has grown larger than the known wireless network 500A (FIG. 5A). For illustrative purposes only, the wireless client 502 remains associated with the access points 504. (In another example, the wireless client could move to a different access point.)

In the example of FIG. 5B, the wireless client 502 can see access points 508 and cannot see access points 506 because they are, for the purposes of this example, too far away. However, a database (not shown) coupled to the known wireless network 500B may still include the data associated with the access points 506. Thus, if a second wireless client (not shown) is near one of the access points 506, data associated with the known wireless network 500B may be able to better locate the second wireless client.

Even if a very rough estimate of access point location is used, the network 500B can grow organically. For example, it could be assumed that if a Wi-Fi hotspot is detected by the wireless client 502, then the Wi-Fi hotspot is within 300 feet. In many real-world situations, this is an overly high number, but nevertheless the estimate is useful. With multiple wireless clients sharing the network, many access points become visible to the system, and some organization of the data can make the location of the access points with respect to one another increasingly accurately known. Some of the access points may be explicitly identified, making them into, essentially, anchors on which to tie surrounding access points.

Known techniques, such as network optimization, can be used to create algorithms for improving the accuracy of locations in the known wireless network. Since locations are typically fairly fuzzy, though within hundreds of feet of accuracy, locations can be given a weight that represents the accuracy of the location. If a user of the wireless client 502 explicitly enters a location, that, too, can be weighted based upon the amount of trust the system has for the user. For example, a new user might not be given much weight when explicitly entering a location, but a user with a proven track record might be given a great deal of weight. Using these techniques, the system is able to more accurately estimate more fuzzy locations using the less fuzzy (or essentially accurate) locations.

It may be noted that the known wireless network 5B could grow by receiving data from other sources than wireless clients. For example, an administrator could enter data about an access point that is not part of the known wireless network 5B, thereby expanding the known wireless network. Any known or convenient technique for increasing the size or accuracy of the known wireless network could be employed, as applicable. It may be desirable to maintain a first database of accurate locations and a second database of fuzzy locations.

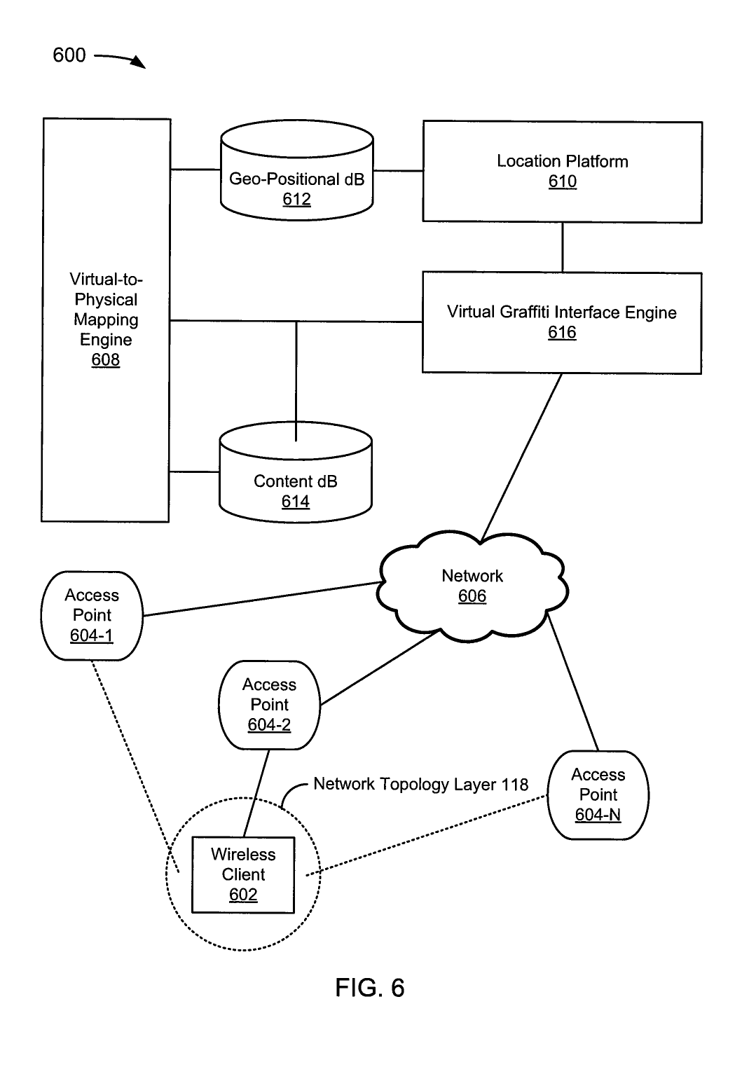

FIG. 6 depicts an example of a system 600 for tying data to a location. The data may be referred to as “virtual graffiti” because the system 600 may facilitate leaving messages, notes, pictures, or other data that are tied to a location. The system 600 relies upon location-detection techniques as described herein to identify the location associated with the virtual graffiti. A virtual graffiti system could also be implemented that uses positioning technologies, such as GPS, in addition to the location-detection techniques described herein. For example, a first user could use positioning technology to tie virtual graffiti to a pinpointed location, and a second user could be informed of the proximity of the virtual graffiti in accordance with the location-detection techniques described herein (or vice versa).

The system 600 includes a wireless client 602, access points 604-1 to 604-N (referred to collectively as access points 604), a network 606, a virtual-to-physical mapping engine 608, a location platform 610, a geo-positional database 612, a content database 614, and a virtual graffiti interface engine 616.

In the example of FIG. 6, the virtual-to-physical mapping engine 608 is coupled to the geo-positional database 612 and the content database 614. The geo-positional database 612 includes data about the physical world, such as, by way of example but not limitation, country name, city name, street address, zip code, GPS coordinates, latitude/longitude, time zone, or other known or convenient data that can be used to identify a geo-location. The content database 614 includes data input by users or administrators that is not part of the physical world, such as, by way of example but not limitation, photos, artwork, prose, poetry, music, or other known or convenient data that a user might find of interest. The virtual-to-physical mapping engine 608 maps the data in the content database 614 to a physical location that is identified in the geo-positional database 612. In this way, a photo can be attached to a location by a first user, and a second user can access the photo when he is near the location (or checking out the area from a distance).

In the example of FIG. 6, in operation when a user of the wireless client 602 intends to write virtual graffiti, the wireless client 602 associates with one of the access points 604. The wireless client 602 sends location-related data through the network 606 to the virtual graffiti interface 616. It may be noted that the location-related data could pass directly to the location platform 610, but for conceptual reasons the virtual graffiti interface 616 is interposed when making reference to FIG. 6. Alternatively, the virtual graffiti interface engine 616 may simply be a part of the location platform 610.

The virtual graffiti interface 616 acquires the probable geo-location of the wireless client 602. In an embodiment, the location platform 610 uses the location-related data from the wireless client 602 to determine the probable location of the wireless client 602. The location platform 610 may use the geo-positional database 612 to help in the determination. In another embodiment, the wireless client 602 may provide an explicit location to the virtual graffiti interface 616. The latter embodiment may prove useful if the location platform 610 is unable to pinpoint the geo-location of the wireless client 602 with a desired accuracy.

For example, a user might want to place virtual graffiti at a specific location, such as the corner of First Street and Main Street. Since location-detection techniques might result in a predicted location that is up to several hundred feet off, the system 600 could end up writing the virtual graffiti in the wrong place. As another example, certain networking techniques (such as VLAN tunneling in some implementations-though not all location-detection techniques will be thwarted with VLAN tunneling) might inadvertently make predicting the geo-location of the wireless client 602 exceptionally difficult. Therefore, a user might need to provide explicit coordinates. Accordingly, it may or may not be desirable, to prompt the user for location-identifying data that are to be associated with the content, or somehow acquire additional location-identifying data.

Such location-identifying data could include any known or convenient data, such as GPS coordinates, street names, latitude/longitude, names of buildings, landmarks, etc. Depending upon the implementation and/or embodiment, it may still be desirable to map such location-identifying data to the real world (e.g., if the location-identifying data includes the name of a restaurant, and the probable location of the wireless client 602 is near the restaurant, it may be desirable to provide, for example, a street address of the restaurant when tying the content to the real world). If so, the location platform 610 may use the geo-positional database 612 to obtain such information in response to, for example, a query from the virtual graffiti interface engine 616.

At some point, in operation when the user of the wireless client 602 intends to write virtual graffiti, the wireless client 602 transmits content to the virtual graffiti interface engine 616. The transmission may be before, after, or at the same time as the transmission of the data that is used to locate, in whatever manner is implemented, the wireless client 602. The virtual graffiti interface engine 616 sends the content and the probable (or actual) location of the wireless client 602 to the virtual-to-physical mapping engine 608, which associates the content with the appropriate location. (It may be noted that although the virtual-to-physical mapping engine 608 is described as a distinct engine for conceptual reasons, it could be part of the location platform 610 and/or the virtual graffiti interface engine 616 in implementation).

The virtual-to-physical mapping engine 608 associates the content with the probable (or actual) geo-location of the wireless client 602, and stores the content in the content database 614. Depending upon the implementation, virtual graffiti may or may not be stored as content with a physical location indicator. If virtual graffiti is stored as content with a physical location indicator (as is assumed in the examples provided herein), the mapping of the data to a geo-location need occur only once. In such an implementation, the content database may be referred to as a “virtual graffiti database,” since the content is at least semi-permanently tied to a physical location.

Content that has been associated with a geo-location may be referred to as “geo-tagged.” In a non-limiting embodiment, geo-tagged content may be associated with more than one location. For example, geo-tagged content could be associated with every international airport in the world. In another non-limiting embodiment, geo-tagged content could be associated with a large geographical area, instead of existing at a point or within a circle. For example, geo-tagged content could be associated with an entire city. Geo-tagged content could even exist at particular elevations (for example, associating geo-tagged content with airspace over the entire state of California).

In the example of FIG. 6, in operation when the wireless client 602 intends to read virtual graffiti, the wireless client 602 associates with one of the access points 604, and a probable or actual geo-location is determined for the wireless client 602, as described previously. The virtual graffiti interface engine 616 determines whether any of content in the content database 614 is associated with a location near the wireless client 602, and provides the content to the wireless client 602. The determination of whether the content is associated with a location near the wireless client 602 may be either relatively static, by checking the content database for an association, or may be dynamic, if the virtual-to-physical mapping engine 608 maps content from the content database 614 to the probable location of the wireless client 602, using the geo-positional database 612.

In an alternative, the wireless client 602 could send a query to the virtual graffiti interface engine 616 regarding a geo-location. In this way, a user could potentially ask about virtual graffiti in an area without actually going there.

In an alternative, all content that is entered by a user of the wireless client 602 could be inherently geo-tagged. For example, if the user enters a personal contact while at a first location, the contact record can remain associated with the first location. The can facilitate an additional way of searching for entries.

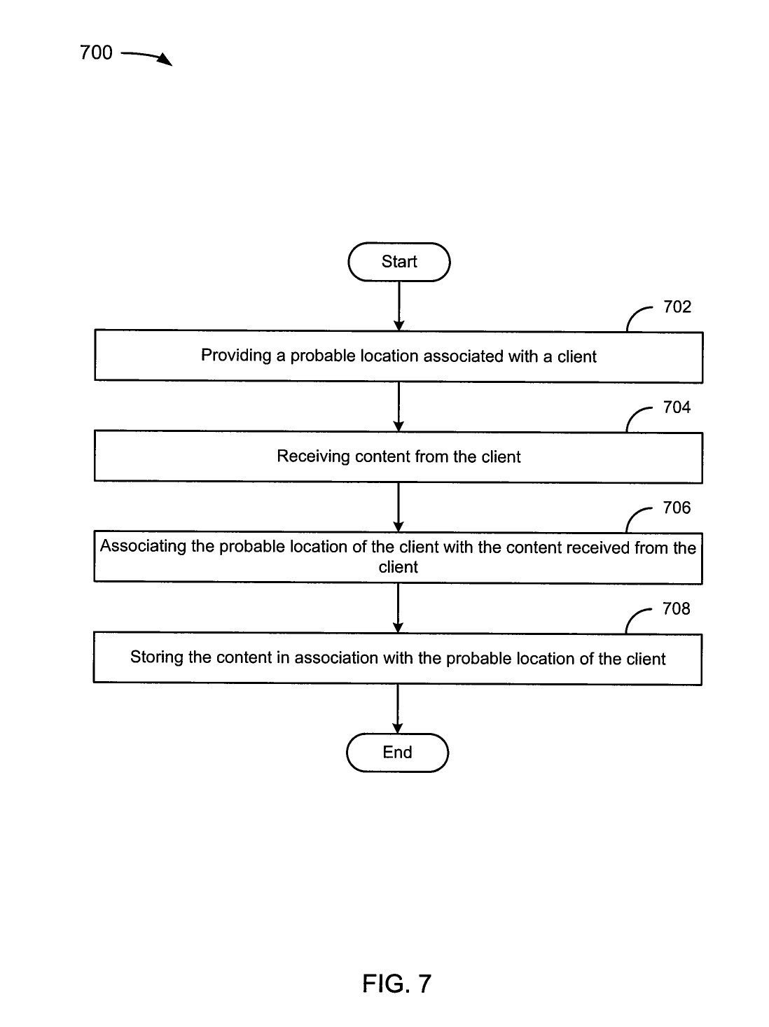

FIG. 7 depicts a flowchart 700 of an example of a method for writing virtual graffiti. It should be noted that “writing” virtual graffiti could include providing any type of content, and is not intended to refer to writing to a data store, writing text, or any other type of storage- or medium-specific input. In the example of FIG. 7, the flowchart 700 starts at module 702 with providing a probable location associated with a client. The probable location may be an actual location, a fuzzy location, or any other location that provides sufficient locality to make virtual graffiti meaningful. For example, if a users want to associated a picture taken of themselves in front of a particular building, the virtual graffiti would be relatively meaningless in association with the building if the provided location were off by several hundred miles.

In the example of FIG. 7, the flowchart 700 continues to module 704 with receiving content from the client. Content could be practically anything that can be put into a format for transmission across a network.

In the example of FIG. 7, the flowchart 700 continues to module 706 with associating the probable location of the client with the content received from the client. It should be noted that content could be auto-tagged at the outset. For example, a picture could be taken on a camera that includes GPS coordinates. Such content would make the associating of the content trivial. However, such cameras tend to be expensive, so in the general case, content will need to be tied to the probable location of the client. Of course, a user could instead provide explicit location associations for content, but that can be tedious.

In the example of FIG. 7, the flowchart 700 continues to module 708 with storing the content in association with the probable location of the client. Since the content is geo-tagged, it could be referred to as virtual graffiti.

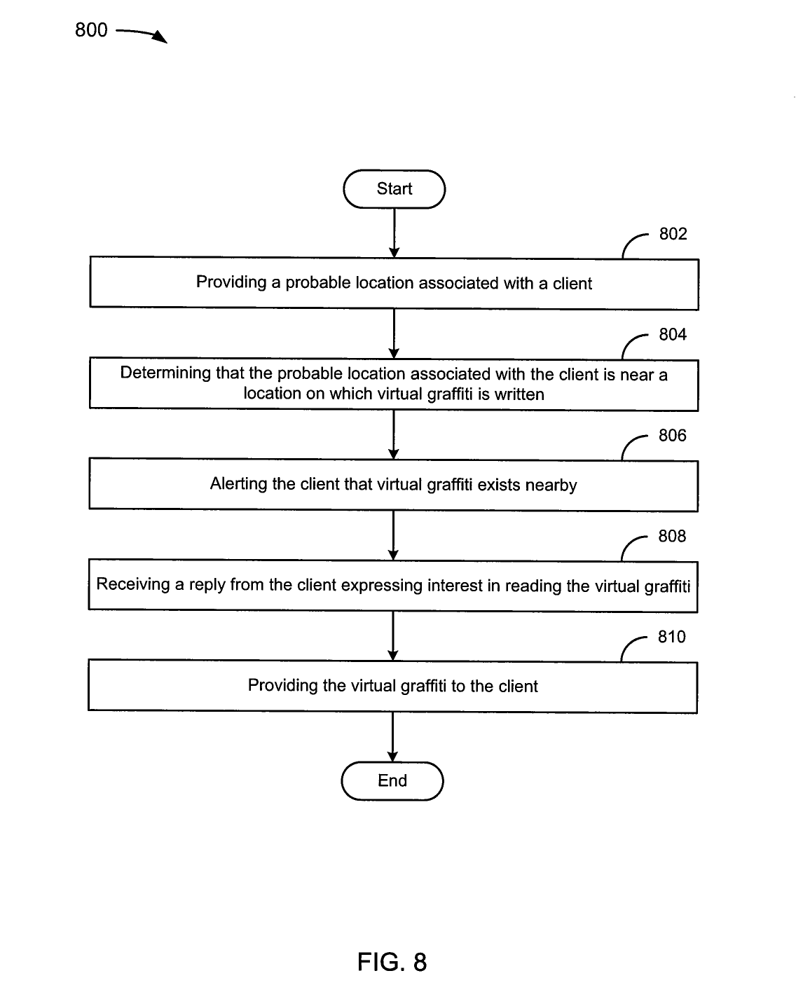

FIG. 8 depicts a flowchart 800 of an example of a method for reading virtual graffiti. By “reading” the intended meaning is simply gaining access to content, in whatever form it may be served. In the example of FIG. 8, the flowchart 800 starts at module 802 with providing a probable location of a client. The probable location could be acquired in any known or convenient manner, such as by using the techniques described herein.

In the example of FIG. 8, the flowchart 800 continues to module 804 with determining that the probable location of the client is near a location on which virtual graffiti is written. Virtual graffiti is, as used herein, simply content that is associated with a location. How that location is compared to the probable location of a client is at least in part an implementation decision. For example, the virtual graffiti could be considered “near” if it is within ¼ mile of the probable location of the client. As another example, the virtual graffiti could be associated with an area and would be considered “near” if the probable location of the client fell within the covered area. As another example, virtual graffiti could have a distance associated with it that varies depending upon the content itself. For example, virtual graffiti written on a city could cover any area of the city, while virtual graffiti written on a landmark could cover any location within a certain distance of the landmark.

In the example of FIG. 8, the flowchart 800 continues to module 806 with alerting the client that virtual graffiti exists nearby. An alert may be triggered when the probable location is near the virtual graffiti. It may be desirable to prevent alerts from being re-triggered for a given time period, until the user moves sufficiently far away, or for some other reason. This can prevent a user from receiving alerts, for example, by walking along the edge of what is defined as near the virtual graffiti, sometimes inside and sometimes outside of the range of the virtual graffiti over a relatively short period of time. The exact means for preventing alerts from being re-triggered is an implementation decision, since any convenient means could be used.

In the example of FIG. 8, the flowchart 800 continues to module 808 with receiving a reply from the client expressing interest in reading the virtual graffiti. How the client replies depends upon how the availability of virtual graffiti is presented. For example, if the client receives a link to the virtual graffiti in an email or instant message, clicking on the link would be the reply. If the virtual graffiti is displayed in a link on a pane or a bulletin board, the client could reply by clicking on the link in the pane.

In the example of FIG. 8, the flowchart 800 continues to module 810 with providing the virtual graffiti to the client. The virtual graffiti could be provided in any format, that would depend upon what the virtual graffiti includes (e.g., .wma for sound or .tif for an image). In an alternative, virtual graffiti could be forced on a client, such as by using a pop-up window or playing the sound (if the virtual graffiti is audio), which could be closed or stopped by user action. Such an alternative would obviate module 808, and module 806 and module 810 would be essentially combined, where the client is alerted that virtual graffiti exists nearby by receiving the virtual graffiti.

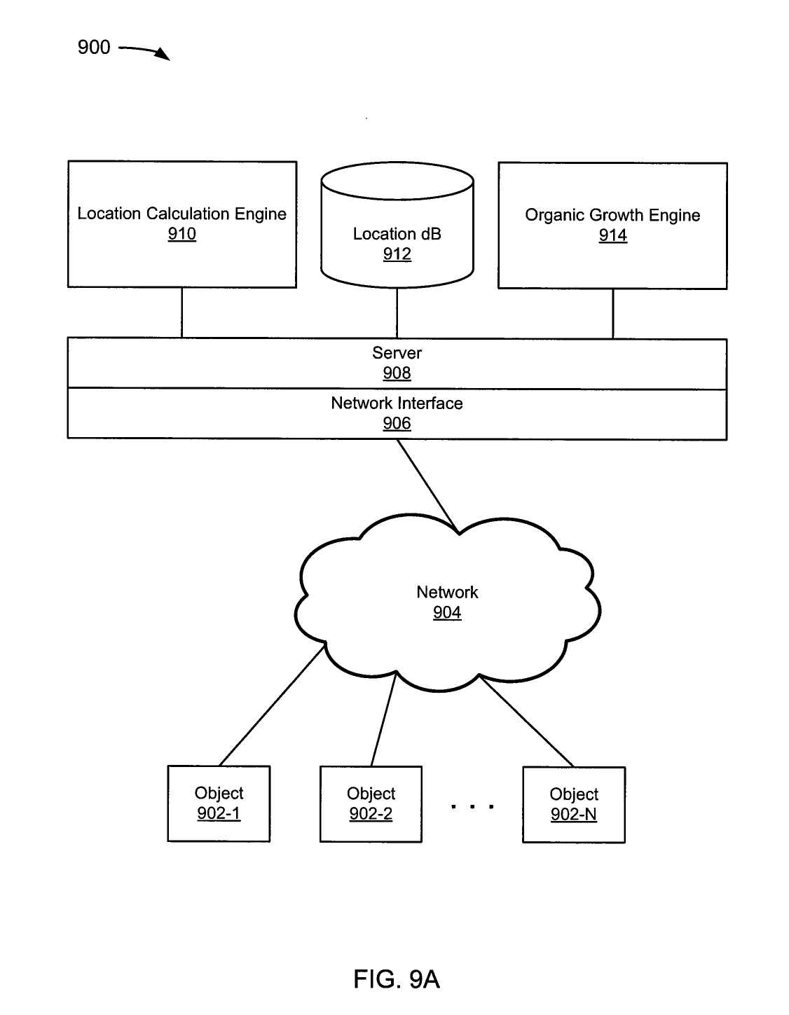

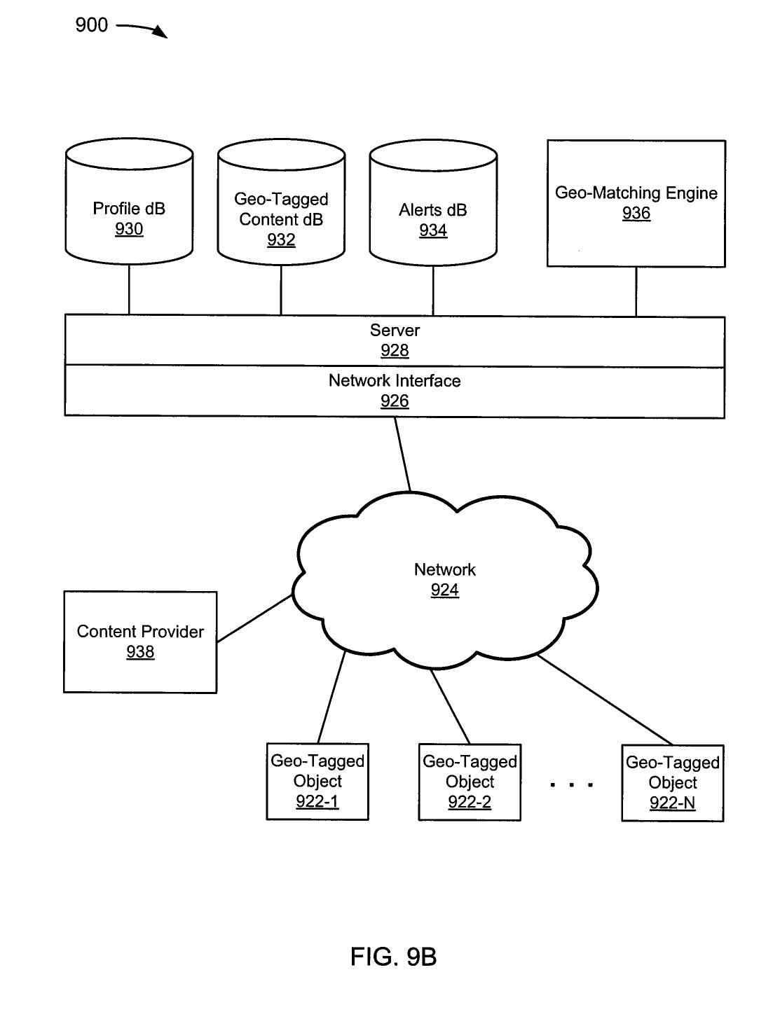

FIGS. 9A and 9B depict an example of a system 900 for geo-matching objects. FIG. 9A depicts a first subset of the system 900, which includes objects 902-1 to 902-N (referred to collectively as objects 902), a network 904, a network interface 906, a server 908, a location calculation engine 910, a location database 912, and an organic growth engine 914. FIG. 9B depicts a second subset of the system 900, which includes geo-tagged objects 922-1 to 922-N (referred to collectively as geo-tagged objects 922), a network 924, a network interface 926, a server 928, a profile database 930, a geo-tagged content database 932, an alerts database 934, a geo-matching engine 936, and a content provider 938.

In the example of FIG. 9A, the objects 902 may have a variety of characteristics. By way of example but not limitation, an object may be a wireless client or some other wireless device, an access point or some other wired device, or an object that is neither wireless nor wired, but that can be detected using a detection mechanism such as radar, sonar, laser, or some other known or convenient location detection device. If an object is neither wired or wireless, it is assumed for the purpose of FIGS. 9A and 9B that, at least when the object is first detected, the detection mechanism (not shown) is connected via a wired or wireless connection to the network 904, and that the object is coupled through the detection mechanism to the network 904. In other respects, the objects 902 are coupled to the network 904 in any known or convenient manner.

In the example of FIG. 9A, the objects 902 are coupled to the network. The network 904 may be any known or convenient network or collection of networks. In the example of FIG. 9A, the server 908 is coupled to the network 904 through the network interface 906.

In a typical implementation, the network interface 906 is a wired interface. However, this is not a requirement (i.e., a server could be wired or wireless). The network interface 906 may include, by way of example but not limitation, an Ethernet network interface or some other network interface. The interface 906 may or may not further include a gateway that provides firewall and other Internet-related services. Alternatively, the network interface 906 could include a modem, such as by way of example but not limitation, an analog modem, ISDN modem, cable modem, satellite transmission interface (e.g. “direct PC”), or other interface for coupling a computer system to other computer systems.

The server 908 is coupled to the location calculation engine 910, the location database 912, and the organic growth engine 914. In an embodiment, the location calculation engine 910 is configured to calculate a location-related value. The exact value may depend upon the embodiment and implementation. For example, the location calculation engine 910 may calculate the relative location of two or more of the objects 902, the distance between two of the objects 902, the relative location of one or more of the objects 902 and a location in the location database, the distance between one or more of the objects 902 and a location in the location database, the relative location of two or more locations in the location database, or a distance between two or more locations in the location database. The probable location of an object 902 may be determined from location data associate with the object that is received on the network interface 906, or a value associated with the object that is already stored in the location database 912.

The location database 912 may include location data related to the objects 902, plus location information that is not directly related to any of the objects 902. For example, if the objects 902 all fall within a first geographical area, the location database 912 may still include location information from a second geographical area. Although location data associated with an object could be stored in a profile database (see, e.g., FIG. 9B, profile database 930), all stored locations are treated herein as logically part of the location database 912, even if stored in separate secondary memory locations on the same or different computers, whether local or remote. Moreover, any of the objects 902 that include positioning technology, such as GPS, are assumed to inform the server 908 of their coordinates, and those coordinates are considered to be a part of the location database 912.

In an embodiment, the organic growth engine 914 is configured to increase the number of locations in the location database, and to increase the accuracy of locations in the database when that is possible. While data can be received in any manner that is implemented such that the location database 912 can be increased in size or accuracy, in an embodiment, the organic growth engine 914 receives, by way of example but not limitation, IP, MAC address, wireless protocol, router, or other data from the objects 902. This data is then translated into a possible location for each of the objects 902, and for objects around the objects 902. For example, if an object is a wireless client, the object could send RSSIs for multiple access points near the object. The organic growth engine 914 may know that all of the detected access points are within a reasonable range of the access point that depends upon the signal, environmental variables, protocols, etc. that may be considered when implementing the decision-making portion of the engine. When considering multiple objects in roughly the same area, the organic growth engine 914 may be able to improve the accuracy of location estimates for the access points by noting that one group is often seen at the same time, and as an object appears to move north, one of the access points becomes undetectable first (suggesting, though not proving, it is further south than the others).

Since the location database includes locations that are not always accurate, it may be desirable to distinguish between “fuzzy locations” and “accurate locations.” The organic growth engine 914 need not try to improve the accuracy of locations that are labeled accurate. What is accurate may vary depending upon the implementation. Accordingly, a hard-and-fast rule regarding when a location is sufficiently accurate to be labeled accurate is probably not useful. For any given implementation, however, an accuracy threshold may be set. If a location is proven or defined to be more accurate than the threshold, then the location may be referred to as an accurate location. Other locations would be referred to as fuzzy locations. In some implementations and/or embodiments, it may be desirable to only allow a location to be labeled as accurate if it is defined that way, forcing the organic growth module 914 to only improve the accuracy of fuzzy locations to more accurate fuzzy locations. Essentially, in this case, the accuracy threshold is “defined only.” Moreover, in some implementations and/or embodiments, it may not be useful to allow any location to be labeled accurate, since even if a location is defined it could be wrong or could change. Essentially, in this case, the accuracy threshold is “never.”

In the example of FIG. 9B, the geo-tagged objects 922 may have a variety of characteristics, much like the objects 902. However, geo-tagged objects 922 are those objects for which the system 900 has a location in the location database 912 (FIG. 9A). While an object with positioning technology, such as GPS, is inherently geo-tagged, such an object would not be one of the geo-tagged objects 922 unless and until the server 908 (FIG. 9A) were informed of the object's coordinates, which would then be logically part of the location database 912 (FIG. 9A).

In the example of FIG. 9B, the network 924 is similar to the network 904, the network interface 926 is similar to the network interface 906, and the server 928 is similar to the server 908. In each of these instances, the component may or may not be identical. The server 928 is coupled to the network 924 through the network interface 926 and is coupled to the profile database 930, the geo-tagged content database 932, the alerts database 934, and the geo-matching engine 936.

In an embodiment, the profile database 930 includes data associated with users of the system 900. At least one of the objects 922 is assumed to be a user. The data in the profile database 930 may include practically anything. For example, the data could include name, address, phone number, favorite restaurant, work address, calendar entries, notes, contacts, club memberships, travel plans, etc. It is practically impossible to list all of the possible data entries that could be included in the profile database 930. It should be noted that locations, even if entered into the profile database 930, are considered to be part of the location database 912 (FIG. 9A). Nevertheless, an address is such an integral part of a typical profile, so it is included in the list above (in any case, a location in the location database 912 may or may not have the same format as an address in the profile database 930).

In an embodiment, the geo-tagged content database 932 includes content in any known or convenient format, including audio, video, text, picture, etc. The content may be geo-tagged with a location that is represented as a point, a circle, a globe, or some other 2-dimensional, 3-dimensional, or 4-dimensional representation. 3-dimensional may mean a 2-dimensional shape with a time-based component (e.g., only during working hours), and 4-dimensional may mean a 3-dimensional shape with a time-based component. Indeed, there could be any number of “dimensions” if other content-display variables are present.

In an embodiment, the alerts database 934 includes rules regarding when content provisioning is triggered. Although the rules need not have any location-based component (e.g., they could be time-based, or even automatic for all or some), it is for the most part assumed herein that the rules do include a location-based component. A typical rule may be that an alert is sent to a geo-tagged client if the client's geo-tag is sufficiently near or inside the location associated with content. The client can then respond to the alert to obtain the content.

The geo-matching engine 936 knows the geo-tags associated with the objects 922. The geo-matching engine 936 is also aware that certain stimuli will trigger an alert from the alerts database. The stimuli may include location, time, or a user-related factor. For example, consider an alert associated with an invitation to a party in San Francisco to any member of the IEEE (this alert could be put out during a conference, for example). The user turns on his cell phone. The user's cell phone associates with a cellular network in the area, and the cell phone location is estimated and stored in the location database 912 (FIG. 9A). At this point the cell phone (and, indirectly, the user) has been geo-tagged. The profile database 930 includes a record for the user, which indicates that the member is also a member of the IEEE. The relevance engine 936 notices that the user is sufficiently near San Francisco and that the user is a member of the IEEE, which are the two requirements to trigger the alert in the alerts database 934. Accordingly, the relevance engine 936 informs the server 928 that an alert is to be sent to the user, which the server does. The alert that is sent to the user is associated with an invitation that is stored in the content database 932. The alert to the user may be in any format (perhaps as indicated as the preferred format in the user's profile), and may or may not include data that explains what the content is (e.g., “you have received an invitation” as a text message). The user can then access the invitation in a known or convenient manner. The user might be able to update a calendar entry in the user profile, and an alert may be stored in the alerts database 934 that relates to updates for those who are attending the party.

In many of the examples, wireless clients are described. However, the techniques described herein can be used to identify the locations of hardware that is wired. In many instances, identifying the location of a wired client is at least no more difficult than identifying the location of a wireless client. Accordingly, wireless client examples have been provided herein, with the understanding that one of skill in the relevant arts could extend the teachings to cover wired clients instead of, or in addition to, wireless clients.

As used herein, an engine is a software, firmware, and/or hardware construct that carries out a particular function or functions. The engine will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A system comprising:
an interface for receiving first location data associated with a first object and second location data associated with a second object;
a database that includes locations;
a location calculation module, wherein, in operation, the processor executes the location calculation module to determine the distance or relative location with respect to the first object and the second object, said determining including:
predicting a first location associated with the first object by comparing the first location data to locations in the database;
predicting a second location associated with the second object by comparing the second location data to locations in the database;
comparing the first location and the second location;
an organic growth module, wherein, in operation, the processor executes the organic growth module to add new locations to the database when the first location data or the second location data identify the new locations.

2. The system of claim 1, wherein the first object is a wireless client.

3. The system of claim 1, wherein the first object is an access point associated with a wireless network.

4. The system of claim 1, wherein the first location data includes one or more data selected from the group consisting of: wireless data, RSSI, client data, access point data, router data, IP data, internal network IP data, external network IP data.

5. The system of claim 4, wherein the second location data includes positional coordinates.

6. The system of claim 1, wherein the first location data is used to predict a first location prior to receipt of the second location data.

7. The system of claim 1, wherein the locations in the database include accurate locations and fuzzy locations, and wherein the organic growth module further improves the accuracy of a fuzzy location if the first location data or the second location data provide sufficient information to improve the accuracy of the fuzzy location, wherein if the accuracy of the fuzzy location is improved beyond an accuracy threshold, the fuzzy location is referred to as an accurate location.

8. A system comprising:
a wireless network database including information about a physical network, wherein the information facilitates creation of a known network model associated with the physical network;
a scouting module for identifying network-related data in the physical network;
a headquarters module, coupled to the wireless network database and the scouting module, for improving accuracy and expanse of the known network model using network-related data received from the scouting module.

9. The system of claim 8, wherein the network related data includes WiFi hotspot-, gateway-, internal network-, and router-related data.

10. The system of claim 8, wherein the scouting module:
collects known or convenient data that can be used to locate a user;
reports the data to the headquarters module for analysis.

11. The system of claim 8, wherein
the scouting module provides a user fingerprint to the headquarters module;
the headquarters module identifies a location of the user within the known network model and a corresponding probable location of the user within the physical network.

12. The system of claim 8, wherein the headquarters module uses extremely local location detection techniques and scalable location detection techniques.

13. The system of claim 8, wherein the headquarters module uses collected data associated with a first user to provide location-related information about the first user to a second user.

14. A method comprising
providing a probable location associated with a client;
receiving content from the client;
associating the probable location of the client with the content received from the client;
storing the content in association with the probable location of the client.

15. The method of claim 14, further comprising prompting the client for location-identifying data to improve accuracy of the probable location.

16. The method of claim 14, further comprising auto-tagging the content with the probable location of the client.

17. The method of claim 14, wherein the client is a first client and wherein the content stored in association with the probable location of the client is virtual graffiti, further comprising:
providing a probable location associated with a second client;
determining that the probable location associated with the second client is near a location on which virtual graffiti is written.

18. The method of claim 17, further comprising alerting the second client that virtual graffiti exists nearby.

19. The method of claim 17, further comprising receiving a reply from the second client expressing interest to view the virtual graffiti.

20. The method of claim 17, further comprising providing the virtual graffiti to the second client.
